(19) United States
(12) Patent Application Publication
(10) Pub. No.: US 2026/0140458 A1
(43) Pub. Date: May 21, 2026

(54) IMAGE FORMING APPARATUS

(71) Applicant: Yoshiki Hozumi, Kanagawa (JP)

(72) Inventor: Yoshiki Hozumi, Kanagawa (JP)

(73) Assignee: Ricoh Company, Ltd., Tokyo (JP)

(21) Appl. No.: 19/181,273

(22) Filed: Apr. 16, 2025

(30) Foreign Application Priority Data
May 2, 2024 (JP) 2024-074748

(51) Int. Cl. G03G 15/01; G03G 15/16; G03G 21/16

(52) U.S. Cl. CPC G03G 15/0136; G03G 15/0189; G03G 15/1615; G03G 21/1647

(57) ABSTRACT

An image forming apparatus includes an image bearer, a transferor, a nip former, a holder, a slider, a pressure spring, and a separator. The transferor transfers a toner image on the image bearer. The nip former causes the transferor to contact the image bearer at a nip forming position to form a transfer nip between the image bearer and the transferor. The holder holds the nip former. The slider is slidable in a first direction. The pressure spring has one end engaged with the slider and another end to press the holder in the first direction to position the nip former at the nip forming position. The separator slides the slider in a second direction opposite the first direction to move the nip former from the nip forming position to a retracted position to separate the transferor from the image bearer.

### CROSS-REFERENCE TO RELATED APPLICATIONS

This patent application is based on and claims priority pursuant to 35 U.S.C. § 119(a) to Japanese Patent Application No. 2024-074748, filed on May 2, 2024, in the Japan Patent Office, the entire disclosure of which is hereby incorporated by reference herein.

### BACKGROUND

### Technical Field

Embodiments of the present disclosure relate to an image forming apparatus.

### Related Art

An image forming apparatus is known that includes a nip former to cause a transferor, onto which an image is transferred from an image bearer, to contact the image bearer to form a transfer nip, a pressure spring to bias a holder holding the nip former to position the nip former at a nip forming position at which the transferor contacts the image bearer, and a separator. The separator includes a slider and slides the slider in an opposite direction to a direction in which the pressure spring biases the holder to move the nip former from the nip forming position to a retracted position.

In the image forming apparatus, the holder holds a primary transfer roller serving as the nip former. The holder is rotatably supported by a frame of the image forming apparatus, and one end of the pressure spring is engaged with the frame and the other end thereof is engaged with the holder. The slider has a protrusion for pushing the holder in the opposite direction when the slider is slid in the opposite direction. The protrusion of the slider pushes the holder in the opposite direction. By so doing, the holder is rotated such that the primary transfer roller moves from the nip forming position to the retracted position.

### SUMMARY

In an embodiment of the present disclosure, an image forming apparatus includes an image bearer, a transferor, a nip former, a holder, a slider, a pressure spring, and a separator. The transferor transfers a toner image on the image bearer. The nip former causes the transferor to contact the image bearer at a nip forming position to form a transfer nip between the image bearer and the transferor. The holder holds the nip former. The slider is slidable in a first direction. The pressure spring has one end engaged with the slider and another end to press the holder in the first direction to position the nip former at the nip forming position. The separator slides the slider in a second direction opposite the first direction to move the nip former from the nip forming position to a retracted position to separate the transferor from the image bearer.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of a printer as an image forming apparatus;

FIG. 2 is a diagram illustrating a hardware configuration of the printer of FIG. 1;

FIG. 3 is a diagram illustrating a skew correction mechanism of an intermediate transfer unit immediately after the skew correction mechanism is assembled, as viewed from the axial direction of a tension roller;

FIG. 4 is a diagram illustrating the skew correction mechanism of FIG. 3, viewed from the axial direction of the tension roller, when an intermediate transfer belt is skewed;

FIG. 5 is a cross-sectional view of the skew correction mechanism of FIG. 3 along a line A-A in FIG. 3;

FIG. 6 is a cross-sectional view of the skew correction mechanism of FIG. 4 along a line A-A in FIG. 4;

FIG. 7 is a diagram illustrating a photoconductor viewed from the left-and-right direction of the printer of FIG. 1;

FIG. 8 is a diagram illustrating positioning of photoconductors on the front side of the printer of FIG. 1;

FIG. 9 is a diagram illustrating positioning of the photoconductors of FIG. 8 on the rear side of the apparatus body;

FIG. 10A is a diagram illustrating an intermediate transfer belt and the surroundings thereof, when the intermediate transfer belt contacts photoconductors in a full-color mode;

FIG. 10B is a diagram illustrating the intermediate transfer belt of FIG. 10A and the surroundings thereof, when the intermediate transfer belt contacts only rightmost one of the photoconductors in a monochrome mode;

FIG. 11 is a diagram illustrating positioning of primary transfer rollers and surroundings thereof on the front side of the printer of FIG. 1, in which the primary transfer rollers are positioned by positioning protrusions of holders disposed on the front side of the printer;

FIG. 12 is a diagram illustrating positions of the primary transfer rollers of FIG. 11 and the surroundings thereof on the rear side of the printer of FIG. 1, in which the primary transfer rollers are positioned by the positioning protrusions of the holders disposed on the rear side of the printer;

FIG. 13A is a diagram illustrating a separator in full-color mode, viewed from the front side of the printer of FIG. 1;

FIG. 13B is a diagram illustrating the separator of FIG. 13A, viewed from above the printer of FIG. 1;

FIG. 14A is a diagram illustrating the separator of FIG. 13A in monochrome mode, viewed from the front side of the printer of FIG. 1;

FIG. 14B is a diagram illustrating the separator of FIG. 14A, viewed from above the printer of FIG. 1;

FIG. 15 is a diagram illustrating an intermediate transfer belt and the surroundings thereof when a winding angle of the intermediate transfer belt wound around the backup roller changes due to skewing of a tension roller;

FIG. 16A is a diagram illustrating a belt separator according to a modification of embodiments of the present disclosure in full-color mode; and

FIG. 16B is a diagram illustrating the belt separator of FIG. 16A in monochrome mode.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an image forming apparatus according to embodiments of the present disclosure, with reference to the accompanying drawings. It is to be understood that those skilled in the art can easily modify and change the present disclosure within the scope of the appended claims to form other embodiments, and these modifications and changes are included in the scope of the appended claims. The following embodiments are illustrative and do not limit the scope of the appended claims.

Hereinafter, embodiments of the present disclosure are described of an electrophotographic color printer, which is referred to simply as a printer 100 in the following description, as an example of an image forming apparatus, with reference to the attached drawings.

First, a description is given of a basic configuration of the printer 100.

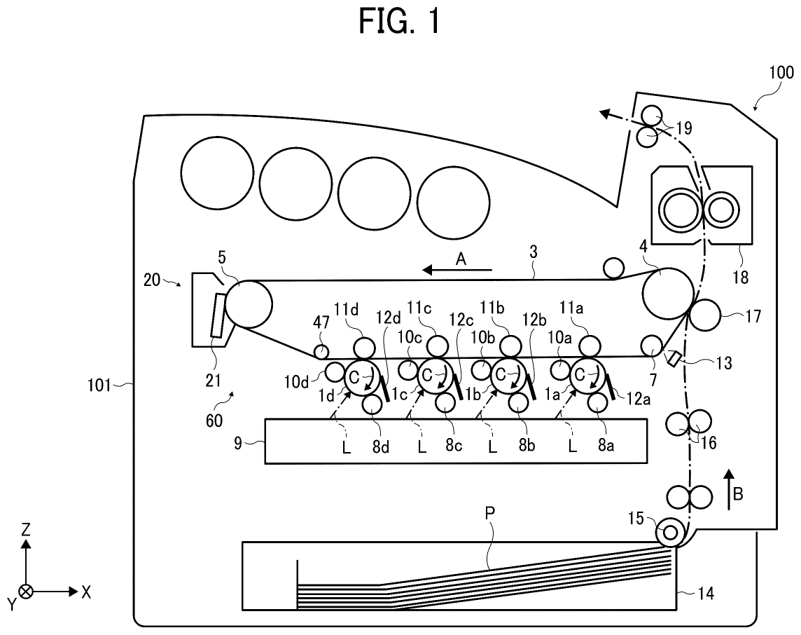

FIG. 1 is a diagram illustrating a configuration of the printer 100. The printer 100 is a tandem-type color printer and includes four photoconductors 1a, 1b, 1c, and 1d as first to fourth image bearers disposed in an apparatus body 101. The printer 100 includes an intermediate transfer unit 60 including an intermediate transfer belt 3, which is a belt that serves as an intermediate transferor, above the four photoconductors 1a, 1b, 1c, and 1d. The intermediate transfer unit 60 is detachable from the apparatus body 101 of the printer 100.

Toner images of different colors are formed on the four photoconductors 1a, 1b, 1c, and 1d.

A black toner image, a magenta toner image, a cyan toner image, and a yellow toner image are formed on the four photoconductors 1a, 1b, 1c, and 1d, respectively. The photoconductors 1a, 1b, 1c, and 1d illustrated in FIG. 1 each have a drum shape. However, an endless belt-shaped photoconductor that is wound around multiple rollers and is rotationally driven may also be employed.

In the intermediate transfer unit 60, the intermediate transfer belt 3 is disposed so as to face the photoconductors 1a, 1b, 1c, and 1d as the first, second, third, and fourth image bearers, respectively. In FIG. 1, the four photoconductors 1a, 1b, 1c, and 1d are in contact with the surface of the intermediate transfer belt 3. The intermediate transfer belt 3 illustrated in FIG. 1 is wound around multiple support rollers such as a secondary transfer counter roller 4, a tension roller 5, an entrance roller 7, and a backup roller 47. The secondary transfer counter roller 4, which is one of the support rollers, is a driving roller driven by a driving source. The intermediate transfer belt 3 is rotationally driven in a direction indicated by arrow A in FIG. 1 by the driving of the secondary transfer counter roller 4.

The intermediate transfer belt 3 may have either a multilayer structure or a single-layer structure. When the intermediate transfer belt 3 has the multilayer structure, it is preferable that the base layer is made of a stretch-resistant material, for example, a fluororesin, a polyvinylidene fluoride (PVDF) sheet, or a polyimide resin, and the surface of the intermediate transfer belt 3 is covered with a coating layer, such as a fluororesin, with good smoothness. When the intermediate transfer belt 3 has the single-layer structure, it is preferable that a material such as PVDF, polycarbonate (PC), or polyimide is employed.

Regardless of the color of toner, the configuration and operation to form toner images on the four photoconductors 1a, 1b, 1c, and 1d are similar. Similarly, the configuration and operation to transfer the toner images onto the intermediate transfer belt 3 are similar regardless of the color of toner. Accordingly, a description is given of the configuration and operations of the photoconductor 1a mainly, out of the four photoconductors 1a, 1b, 1c, and 1d. The photoconductor 1a for forming a black toner image is disposed extreme downstream in a surface movement direction of the intermediate transfer belt 3. The photoconductor 1a forms the black toner image and transfers the black toner image onto the surface of the intermediate transfer belt 3. Descriptions of the configuration and operation of the photoconductors 1b, 1c, and 1d forming other toner color images (cyan toner image, magenta toner image, and yellow toner image) are omitted to avoid redundancy.

The photoconductor 1a that forms the black toner image is rotationally driven in the clockwise direction in FIG. 1 as indicated by an arrow C in FIG. 1. Hereinafter, the photoconductor 1a that forms the black toner image is simply referred to as the photoconductor 1a. As the photoconductor 1a is rotated, the surface of the photoconductor 1a is irradiated with light from a static eliminator. Consequently, the surface potential of the photoconductor 1a is initialized. The photoconductor 1a is further rotated and reaches a position where the photoconductor 1a faces a charging device, and the charging device uniformly charges the initialized surface of the photoconductor 1a to a given polarity (in the present embodiment, to a negative polarity). The exposure device 9 emits an optically modulated laser beam L onto the charged surface of the photoconductor 1a to form an electrostatic latent image corresponding to image data on the surface of the photoconductor 1a. In the printer 100 illustrated FIG. 1, the exposure device 9 as a laser writer emits laser beams L. Alternatively, the exposure device 9 may include a light-emitting diode (LED) array and an imaging device.

The electrostatic latent image formed on the surface of the photoconductor 1a is visualized as a visible black toner image when the electrostatic latent image passes a developing device 10a for black. By contrast, a primary transfer roller 11a for black, which is a nip former and a primary transferor, is disposed inside the loop of the intermediate transfer belt 3 at a position facing the photoconductor 1a with the intermediate transfer belt 3 interposed therebetween. The primary transfer roller 11a contacts the back surface of the intermediate transfer belt 3 to form an appropriate primary transfer nip between the photoconductor 1a and the intermediate transfer belt 3.

A primary transfer bias is applied to the primary transfer roller 11a for black color. The primary transfer bias has a positive polarity in the present embodiment, which is opposite the charging polarity of toner contained in the toner image formed on the surface of the photoconductor 1a. Accordingly, a transfer electrical field is generated between the photoconductor 1a and the intermediate transfer belt 3. The black toner image on the photoconductor 1a is electrostatically transferred onto the intermediate transfer belt 3 that is rotated in synchronization with the photoconductor 1a. After the black toner image is transferred onto the intermediate transfer belt 3, a cleaner 12a for black color having an identical configuration to cleaners 12b, 12c, and 12d removes residual toner remaining on the surface of the photoconductor 1a to clean the surface of the photoconductor 1a.

Similarly, a magenta toner image, a cyan toner image, and a yellow toner image are formed on the other three photoconductors 1b, 1c, and 1d, respectively. The toner images of yellow, cyan, magenta, and black are electrostatically and sequentially transferred one on another onto the intermediate transfer belt 3 in the order listed.

As illustrated in FIG. 1, the printer 100 further includes a sheet feeder 14 in a lower portion of the apparatus body 101. The sheet feeder 14 includes a sheet feed roller 15. As the sheet feed roller 15 rotates, a sheet P as a recoding medium is fed out in a direction indicated by arrow B in FIG. 1. The sheet P that is fed out from the sheet feeder 14 contacts a pair of registration rollers 16 and stops temporarily.

A portion of the intermediate transfer belt 3 is wound around the secondary transfer counter roller 4. The portion of the intermediate transfer belt 3 contacts a secondary transfer roller 17 that functions as a secondary transferor facing the secondary transfer counter roller 4. The sheet P that has contacted the pair of registration rollers 16 is conveyed to a secondary transfer nip at a given timing. At this time, a given transfer voltage is applied to the secondary transfer roller 17, so that a composite toner image formed by overlaying the single color toner images on the intermediate transfer belt 3 is secondarily transferred onto the sheet P.

The sheet P onto which the composite toner image is secondarily transferred is further conveyed upward in the apparatus body 101 to pass the fixing device 18. While the sheet P passes through the fixing device 18, the composite toner image on the sheet P is fixed onto the sheet P by application of heat and pressure in the fixing device 18. The sheet P that has passed through the fixing device 18 is ejected to the outside of the printer 100 by a pair of sheet ejection rollers 19 disposed in a sheet ejection device.

After the toner image is transferred onto the sheet P, some toner remains as transfer residual toner on the surface of the intermediate transfer belt 3. The transfer residual toner is removed from the intermediate transfer belt 3 by a belt cleaning device 20. The belt cleaning device 20 includes a cleaning blade 21 that is a blade-shaped urethane cleaning body. The cleaning blade 21 is disposed in contact with the surface of the intermediate transfer belt 3 in a counter direction with respect to the surface movement direction of the intermediate transfer belt 3. Various types of belt cleaning devices can be employed as the belt cleaning device 20. For example, the belt cleaning device 20 may be an electrostatic belt cleaning device.

The untransferred toner that is removed from the intermediate transfer belt 3 by the cleaning blade 21 is sent to the rear side of the apparatus body 101 in a longitudinal direction of the apparatus body 101 by a waste-toner coil in a cleaning case of the belt cleaning device 20, and is conveyed to a waste-toner container via a waste-toner conveyance path in the apparatus body 101.

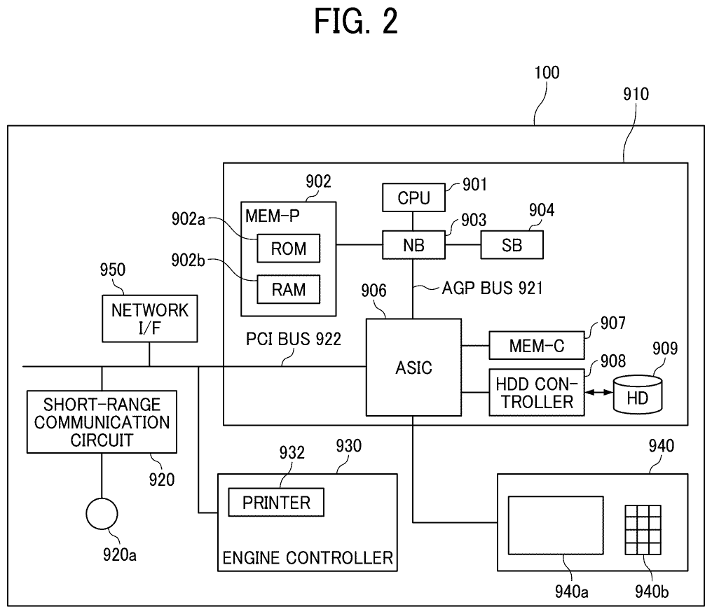

FIG. 2 is a diagram illustrating a hardware configuration of printer 100.

As illustrated in FIG. 2, the printer 100 includes a controller 910, a short-range communication circuit 920, an engine controller 930, an operation panel 940, and a network interface (I/F) 950.

The controller 910 controls the entire operation of the printer 100 and controls, for example, drawing, communication, and input from the operation panel 940.

The controller 910 includes a central processing unit (CPU) 901, a system memory (MEM-P) 902, a northbridge (NB) 903, a southbridge (SB) 904, an application specific integrated circuit (ASIC) 906, a local memory (MEM-C) 907 that is a storage, a hard disk drive (HDD) controller 908, and a hard disk (HD) 909 that is a storage. The NB 903 and ASIC 906 are connected to each other by an accelerated graphics port (AGP) bus 921.

The CPU 901 is a control unit that performs overall control of the printer 100. The NB 903 connects the CPU 901, with the MEM-P 902, the SB 904, and the AGP bus 921. The NB 903 includes a memory controller for controlling reading or writing of various data with respect to the MEM-P 902, a peripheral component interconnect (PCI) master, and an AGP target.

The MEM-P 902 includes a read-only memory (ROM) 902a as a memory that stores programs and data for implementing various functions of the controller 910. The MEM-P 902 further includes a random-access memory (RAM) 902b as a memory that deploys the programs and data, or as a drawing memory that stores drawing data for printing. The program that is stored in the RAM 902b may be stored in any computer-readable storage medium, such as a compact disc-read-only memory (CD-ROM), a compact disc-recordable (CD-R), or a digital versatile disc (DVD), in a file format installable or executable by a computer.

The SB 904 is a bridge that connects the NB 903 to a PCI device and a peripheral device. The ASIC 906 is an integrated circuit (IC) for image processing and includes hardware elements for image processing. The ASIC 906 serves as a bridge to connect the AGP bus 921, a PCI bus 922, the HDD controller 908, and a MEM-C 907. The ASIC 906 includes a PCI target, an AGP master, an arbiter (ARB) as a central processor of the ASIC 906, a memory controller, multiple direct memory access controllers (DMACs), and a PCI unit. The memory controller controls the MEM-C 907. The DMACs convert coordinates of image data with a hardware logic. The PCI unit transfers data between the multiple DMAICs and the printer unit 932 via the PCI bus 922. An interface of a universal serial bus (USB) or an interface of an institute of electrical and electronics engineers 1394 (IEEE 1394) may be connected to the ASIC 906.

The MEM-C 907 is a local memory used as an image buffer for copying and a code buffer. The HD 909 is a storage that stores various image data, font data for printing, and form data. The HDD controller 908 reads or writes various data from or to the HD 909 under control of the CPU 901. The AGP bus 921 is a bus interface for a graphics accelerator card that increases the speed of graphics processing. The CPU 901 directly accesses the MEM-P 902 with high throughput. By so doing, the graphics accelerator card can perform in high speed.

The short-range communication circuit 920 further includes a short-range communication circuit 920a. The short-range communication circuit 920 is a communication circuit that communicates in compliance with, for example, a near field communication (NFC) or the Bluetooth (registered trademark).

The engine controller 930 controls the printer unit 932 to control an image forming operation. The printer unit 932 includes a driving unit to drive and rotate the photoconductors 1a, 1b, 1c, and 1d, a driving unit to drive and rotate the intermediate transfer belt 3, and devices to form an image on the sheet P, such as the developing device 10a, 10b, 10c, and 10d. The printer unit 932 also includes an image processing unit to perform, for example, error diffusion, gamma conversion.

The operation panel 940 that serves as an operation input unit includes a panel display unit 940a and an operation unit 940b. The panel display unit 940a includes, for example, a touch panel that displays, for example, current setting values, a selection screen and receives input from the operator. The operation unit 940b includes, for example, a numeric keypad for receiving a setting value of a condition relating to image formation such as a setting condition of density, and a start key for receiving a copy start instruction.

The printer 100 can sequentially switch among a document server function, a printer function, and a facsimile function in accordance with input via, for example, an application switch key on the operation panel 940. The operator selects the document server function to set the printer 100 in the document server mode, selects the print function to set the printer 100 in a printer mode, and selects the facsimile function to set the printer 100 in a facsimile mode.

The network I/F 950 is an interface that controls communication of data via a communication network. The short-range communication circuit 920 and the network I/F 950 are electrically connected to the ASIC 906 via the PCI bus 922.

The intermediate transfer unit 60 of the present embodiment includes a skew correction mechanism to correct skewing of the intermediate transfer belt 3.

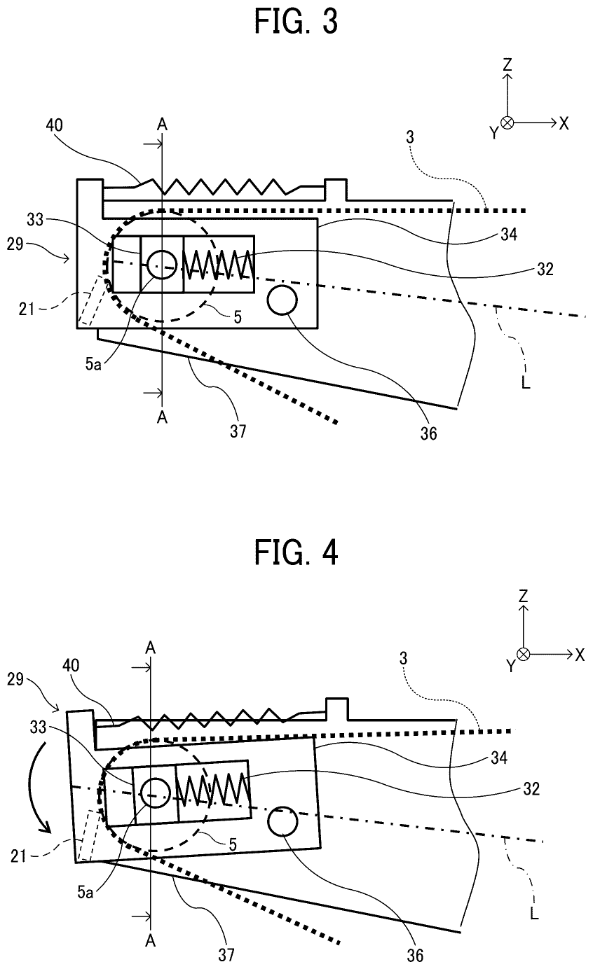

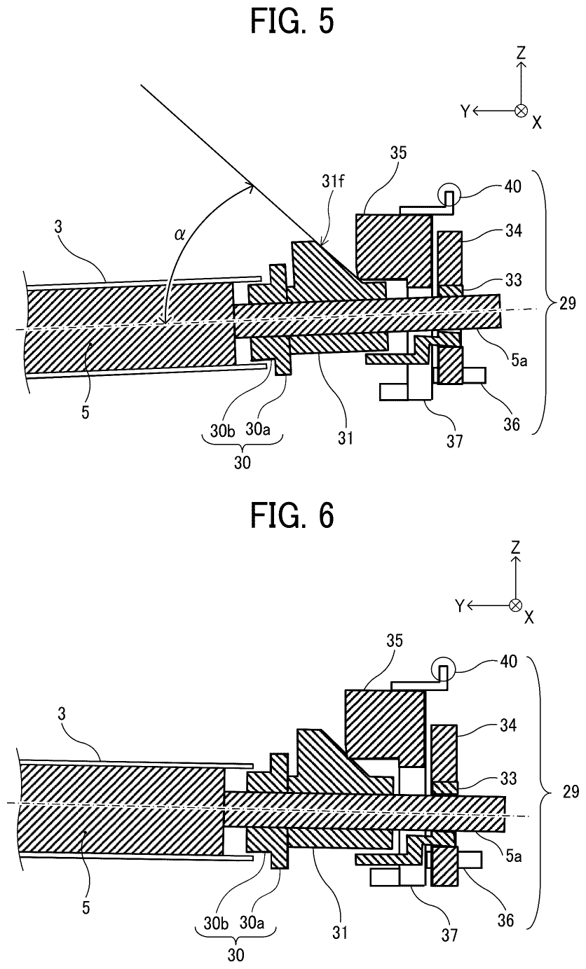

FIG. 3 is a diagram illustrating a skew correction mechanism 29 of the intermediate transfer unit 60 immediately after the skew correction mechanism 29 is assembled, as viewed from the axial direction of the tension roller 5. The axial direction of the tension roller 5 may also be referred to simply as the axial direction in the following description. FIG. 4 is a diagram illustrating the skew correction mechanism 29, viewed from the axial direction, when the intermediate transfer belt 3 is skewed. FIG. 5 is a cross-sectional view of the skew correction mechanism 29 along a line A-A in FIG. 3. FIG. 5 is a cross-sectional view of the skew correction mechanism 29 along a line A-A in FIG. 4.

The tension roller 5 includes a tension roller shaft 5a coaxial with the rotation shaft of the tension roller 5 outside ends of the tension roller 5 in the axial direction. The tension roller shaft 5a has a cylindrical form having a diameter smaller than the diameter of the tension roller 5, and is joined to the tension roller 5. The tension roller shaft 5a is supported by the skew correction mechanism 29 at ends of the tension roller shaft 5a in the axial direction.

As illustrated in FIGS. 3 and 4, the skew correction mechanism 29 includes a tension roller bearing 33 to apply tension to the tension roller 5 while supporting the tension roller 5, and a tension spring 32 to apply tension to the tension roller bearing 33. The skew correction mechanism 29 also includes a roller shaft support 34 that is rotatably supported by an intermediate transfer frame 37 by a rotation shaft 36. The skew correction mechanism 29 also includes a support spring 40 to support the roller shaft support 34. The support spring 40 biases the roller shaft support 34 in the clockwise direction in FIGS. 3 and 4.

As illustrated in FIGS. 5 and 6, the skew correction mechanism 29 includes a belt skew detector 30, a shaft inclining member 31, the intermediate transfer frame 37, and the roller shaft support 34 in the order listed from an inner side of the tension roller shaft 5a in the axial direction. The tension roller shaft 5a penetrates the belt skew detector 30, the shaft inclining member 31, the intermediate transfer frame 37, and the roller shaft support 34. The each of ends of the tension roller shaft 5a in the axial direction is supported by the roller shaft support 34 via the tension roller bearing 33.

The belt skew detector 30 and the shaft inclining member 31 are supported so as to be freely movable in the axial direction with respect to the tension roller shaft 5a. The belt skew detector 30 includes a flange portion 30a having an outer diameter larger than that of the tension roller 5 on the outer side from a cylindrical portion 30b in the axial direction, having a smaller diameter than that of the tension roller 5. When the intermediate transfer belt 3 is skewed, an end of the intermediate transfer belt 3 in the width direction contacts the inner surface of the flange portion 30a in the axial direction.

The shaft inclining member 31 includes an inclined surface 31f inclined relative to the tension roller shaft 5a in an upper portion of the shaft inclining member 31. A shaft guide 35 is coupled with the intermediate transfer frame 37 of the intermediate transfer unit 60. The shaft guide 35 contacts the inclined surface 31f from the outside (right side in FIG. 5) of the tension roller shaft 5a in the axial direction. The shaft inclining member 31 and the shaft guide 35 contact each other. By so doing, the rotation position of the roller shaft support 34 is held against the biasing force of the support spring 40.

In the present embodiment, an inclination angle (angle “α” in FIG. 5) of the inclined surface 31f with respect to the tension roller shaft 5a is 30°, and the material of the shaft inclining member 31 is polyacetal (POM), but are not limited thereto.

As illustrated in FIGS. 3 and 4, the rotation shaft 36 that axially supports the roller shaft support 34 is disposed at a position opposite a position at which the shaft inclining member 31 and the shaft guide 35 contact each other across a bisector L of an angle formed by the intermediate transfer belt 3. Such a configuration allows a force to move the shaft inclining member 31 illustrated in FIGS. 5 and 6, toward the shaft guide 35. Thus, the shaft inclining member 31 and the shaft guide 35 can be brought into contact with each other.

Next, a description is given of the operation of the skew correction mechanism 29.

When the secondary transfer counter roller 4 as the driving roller starts to rotate, the tension roller 5 as the driven roller around which the intermediate transfer belt 3 is wound also starts to rotate. At this time, when the end or the vicinity of the end of the intermediate transfer belt 3 is in contact with the belt skew detector 30, the belt skew detector 30 also starts to rotate.

In the above-described state, when the intermediate transfer belt 3 is shifted and skewed to the right in FIG. 5 due to the influence of parallelism between the members of the skew correction mechanism 29, a right end of the intermediate transfer belt 3 in the width direction contacts the flange portion 30a of the belt skew detector 30. When the belt skew detector 30 receives the force from the intermediate transfer belt 3, the belt skew detector 30 moves outward in the axial direction (rightward in FIG. 5). When the belt skew detector 30 moves outward in the axial direction, the shaft inclining member 31 is pressed outward in the axial direction by the belt skew detector 30. Accordingly, the shaft inclining member 31 also moves outward in the axial direction.

When the shaft inclining member 31 moves outward in the axial direction, the shaft guide 35 in contact with the inclined surface 31f of the shaft inclining member 31 relatively moves along the inclined surface 31f (see FIG. 6). Accordingly, the contact position at which the inclined surface 31f and the shaft guide 35 contact each other is shifted to an upper side of the inclined surface 31f.

The shaft guide 35 is a part of the intermediate transfer frame 37 fixed to the apparatus body 101 of the printer 100. Accordingly, the shaft guide 35 is not shifted upward, and the shaft inclining member 31 having the inclined surface 31f moves downward by the reaction force which the shaft inclining member 31 receives from the shaft guide 35. As a result, the end of the tension roller shaft 5a in an area in which the intermediate transfer belt 3 moves while being skewed and shifted is pressed down against the biasing force of the support spring 40 that moves upward (see FIG. 4). As a result, the tension roller shaft 5a is inclined.

As the tension roller shaft 5a is inclined as described above, the moving speed of the intermediate transfer belt 3 in the width direction is gradually reduced. Finally, the intermediate transfer belt 3 moves in a direction opposite the width direction. As a result, the position of the intermediate transfer belt 3 in the width direction is gradually returned to a normal position, and skew of the intermediary transfer belt 3 is corrected. Accordingly, the intermediate transfer belt 3 can stably travel at the normal position in the width direction.

This is the same as in a case in which intermediate transfer belt 3 is skewed in the opposite direction (leftward in FIG. 5).

Next, a description is given of positioning of the photoconductors 1a, 1b, 1c, and 1d in the apparatus body 101 of the printer 100.

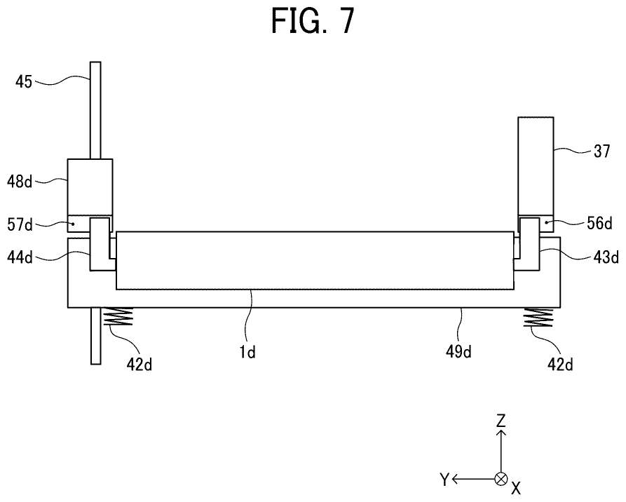

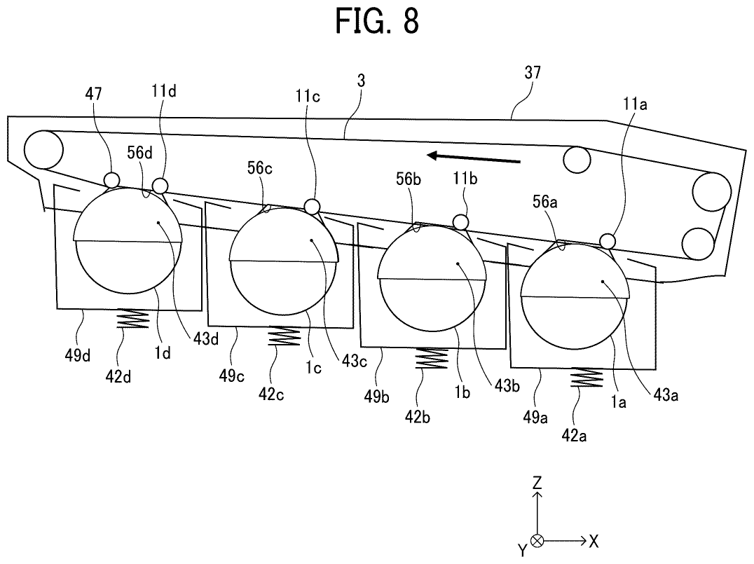

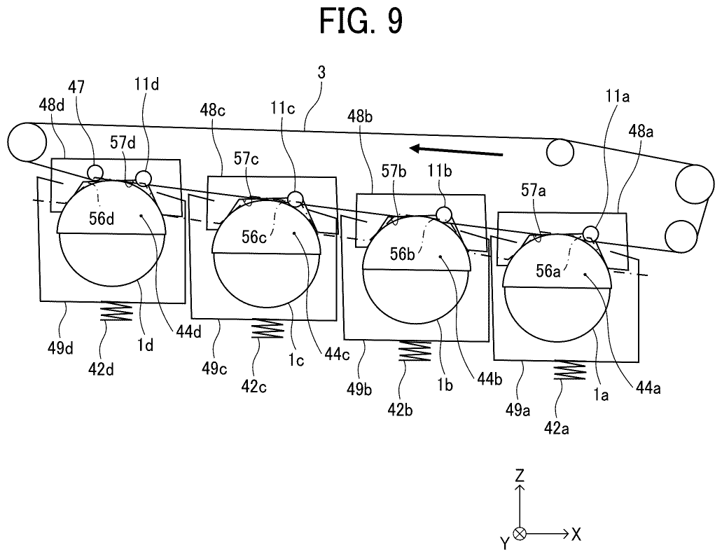

FIGS. 7, 8, and 9 are diagrams each illustrating the positioning of the photoconductors 1a, 1b, 1c, and 1d in the apparatus body 101. FIG. 7 is a diagram illustrating the photoconductor 1d viewed from the left-and-right direction (X direction) of the apparatus body 101. FIG. 8 is a diagram illustrating the positioning of the photoconductors 1a, 1b, 1c, and 1d on the front side of the apparatus body 101. FIG. 9 is a diagram illustrating the positioning of the photoconductors 1a, 1b, 1c, and 1d on the rear side of the apparatus body 101.

The photoconductors 1a, 1b, 1c, and 1d are rotatably held by photoconductor frames 49a, 49b, 49c, and 49d, respectively.

At both ends of the shaft of the photoconductors 1a, 1b, 1c, and 1d, positioning contact members 43a, 43b, 43c, and 43d, respectively, and positioning contact members 44a, 44b, 44c, and 44d, respectively, for positioning the photoconductors 1a, 1b, 1c, and 1d, respectively, in the apparatus body 101 of the printer 100 are disposed. As illustrated in FIGS. 8 and 9, the positioning contact members 43a, 43b, 43c, and 43d and the positioning contact members 44a, 44b, 44c, and 44d each has a semicircular shape having substantially the same diameter as the photoconductors 1a, 1b, 1c, and 1d. The photoconductor frames 49a, 49b, 49c, and 49d are biased by springs 42a, 42b, 42c, and 42d, respectively, which are biasing members, on the front side and the rear side of the apparatus body 101 toward the intermediate transfer unit 60.

As illustrated in FIGS. 7 and 8, the positioning contact members 43a, 43b, 43c, and 43d on the front side of the apparatus body 101 are fitted into positioning recesses 56a, 56b, 56c, and 56d, respectively, each having a recessed shape, disposed in a lower portion of the intermediate transfer frame 37 on the front side of the apparatus body 101.

The positioning contact members 43a, 43b, 43c, and 43d contact the positioning recesses 56a, 56b, 56c, and 56d, respectively, by the biasing force of the springs 42a, 42b, 42c, and 42d, respectively, and are positioned.

As illustrated in FIGS. 7 and 9, the positioning contact members 44a, 44b, 44c, and 44d on the rear side of the apparatus body 101 are fitted into positioning recesses 57a, 57b, 57c, and 57d, respectively, disposed on positioning holders 48a, 48b, 48c, and 48d, respectively, attached to a body structure 45 on the rear side of the apparatus body 101. The positioning contact members 43a, 43b, 43c, and 43d contact the positioning recesses 56a, 56b, 56c, and 56d, respectively, by the biasing force of the springs 42a, 42b, 42c, and 42d, respectively, and are positioned.

The positioning recesses 56a, 56b, 56c, and 56d are indicated by dashed lines in FIG. 9. The positioning recesses 56a, 56b, 56c, and 56d are arranged on the intermediate transfer frame 37, which is disposed on the front side of the apparatus body 101. The positioning recesses 57a, 57b, 57c, and 57d and the positioning recesses 56a, 56b, 56c, and 56d, respectively, of the intermediate transfer frame 37 are disposed at similar positions.

Such a configuration described above prevents the photoconductors 1a, 1b, 1c, and 1d from being inclined vertically and horizontally. Accordingly, the photoconductors 1a, 1b, 1c, and 1d are accurately positioned in the apparatus body 101 of the printer 100.

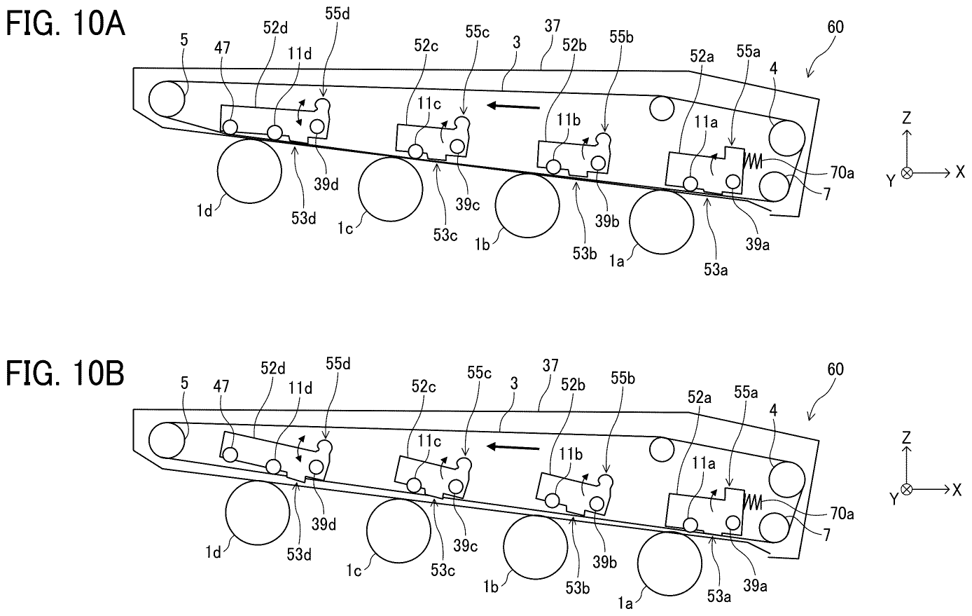

The printer 100 has two types of operation modes, a full-color mode in which four color toners are used, and a monochrome mode in which the black color toner alone is used. In the full-color mode, as illustrated in FIG. 10A, the intermediate transfer belt 3, and each of the four photoconductors 1a, 1b, 1c, and 1d contact each other, and the four color toner images are transferred onto the intermediate transfer belt 3. By contrast, as illustrated in FIG. 10B, in the monochrome mode, the photoconductor 1a alone contacts the intermediate transfer belt 3. Thus, only the black toner image is transferred to the intermediate transfer belt 3.

Both ends of each of the primary transfer rollers 11a, 11b, 11c, and 11d in the axial direction are rotatably supported by holders 52a, 52b, 52c, and 52d, respectively. Each of the holders 52a, 52b, 52c, and 52d is rotatably supported by a support shaft 39a, 39b, 39c, and 39d, respectively, disposed on the intermediate transfer frame 37.

In the present embodiment, the backup roller 47 is disposed between the tension roller 5 and the primary transfer roller 11d for yellow disposed most upstream in the movement direction of the intermediate transfer belt 3.

The backup roller 47 forms a primary transfer nip, i.e., a primary transfer nip for yellow, at a position most upstream in the movement direction of the intermediate transfer belt 3, in a desired shape. The holder 52d for yellow that holds the primary transfer roller 11d for yellow is also rotatably supported by the backup roller 47.

In the monochrome mode, a separator 80 to be described later causes the holders 52b for magenta, 52c for cyan, and 52d for yellow to rotate and moves the three primary transfer rollers 11b, 11c, 11d, and the backup roller 47 from respective nip forming positions to respective retracted positions. Accordingly, the intermediate transfer belt 3 is separated from the photoconductors 1b, 1c, and 1d.

In the monochrome mode, the backup roller 47 is also moved to the retracted position. By so doing, the intermediate transfer belt 3 can be prevented from contacting the photoconductor 1d for yellow. In the present embodiment, the backup roller 47 is held by the holder 52d that holds the primary transfer roller 11d for yellow. Such a configuration can reduce the number of components, achieve downsizing, cost reduction, and simplification of the structure of the image forming apparatus, as compared with a configuration in which each of the primary transfer rollers 11a, 11b, and 11c is held by respective backup rollers.

Each of the holders 52a, 52b, 52c, and 52d includes a pressed portion 55a, 55b, 55c, and 55d, respectively, and positioning protrusions 53a, 53b, 53c, and 53d, respectively. The positioning protrusions 53a, 53b, 53c, and 53d of the holders 52a, 52b, 52c, and 52d, respectively, cause the primary transfer rollers 11a, 11b, 11c, and 11d, respectively, to contact the photoconductors 1a, 1b, 1c, and 1d, respectively, with the intermediate transfer belt 3 interposed therebetween. By so doing, the positioning protrusions 53a, 53b, 53c, and 53d position the primary transfer rollers 11a, 11b, 11c, and 11d, respectively, at respective nip forming positions at which the primary transfer nips are formed.

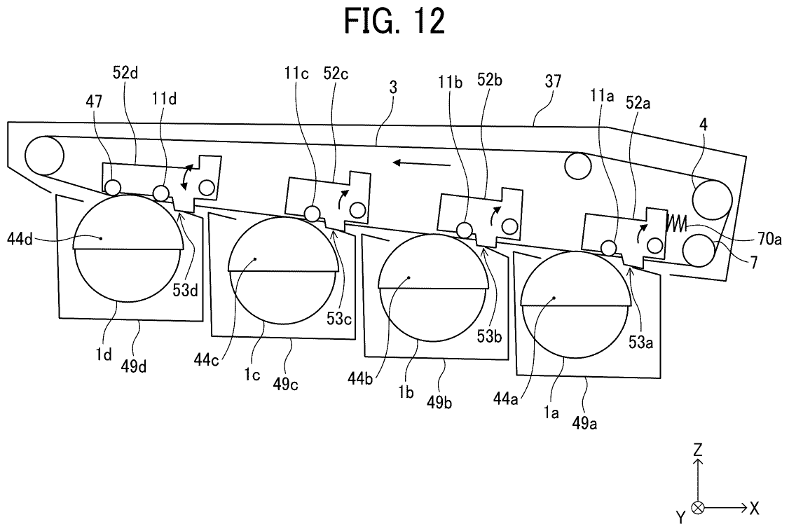

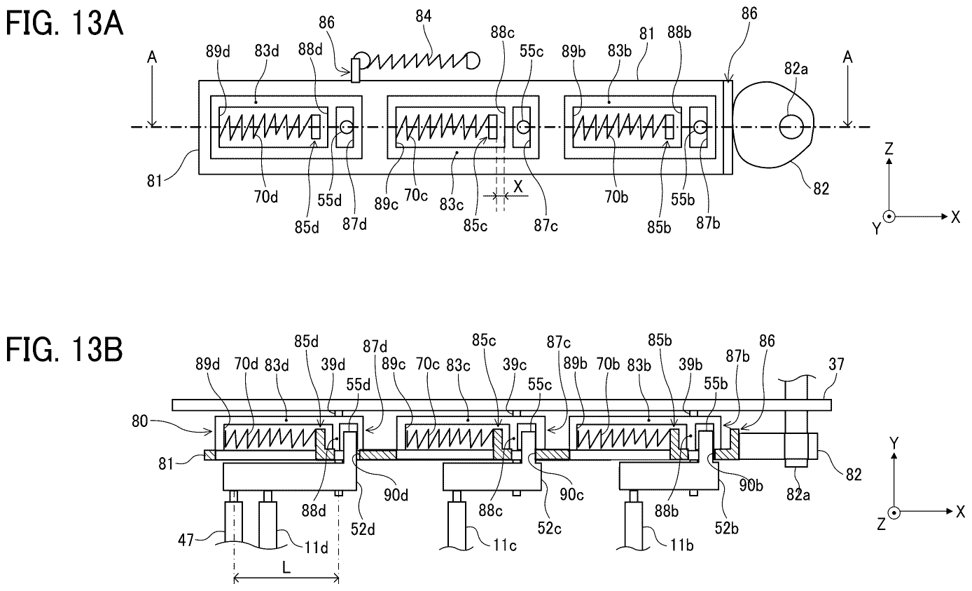

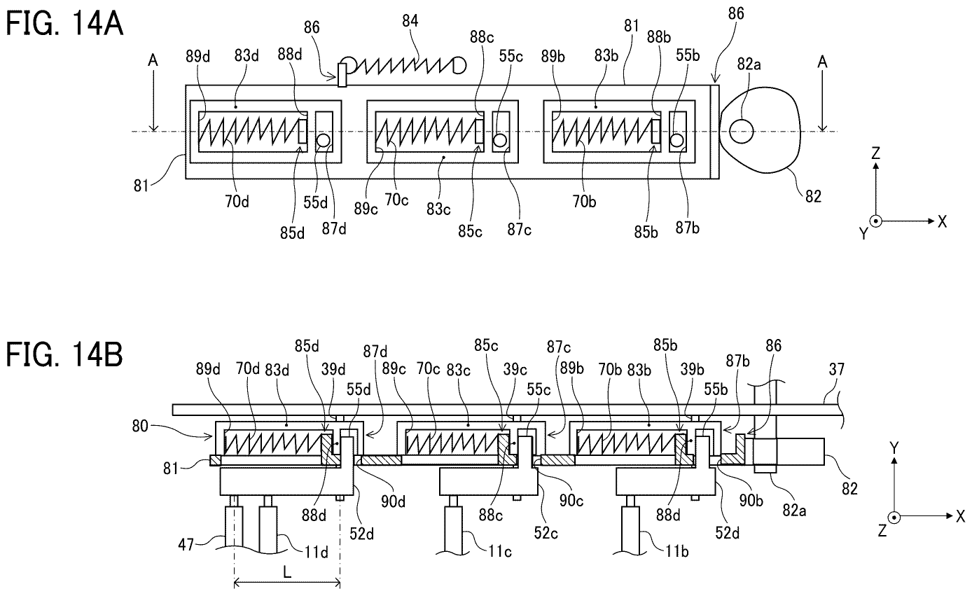

The pressed portion 55a of the holder 52a for black directly receives a biasing force from a pressure spring 70a. Accordingly, the primary transfer roller 11a for black is biased to be positioned at the nip forming position. By contrast, the pressed portions 55b, 55c, and 55d of the holders 52b for magenta, 52c for cyan, and 52d for yellow, respectively, extend outward in the axial direction of the support shaft 39b, 39c, and 39d, respectively. The primary transfer rollers 11b, 11c, and 11d receive biasing forces (pressing forces) of the pressure springs 70b, 70c, and 70d, respectively, via pressure relays 83b, 83c, and 83d, respectively, of the separator 80 described later (see FIGS. 13 and 14). Accordingly, the primary transfer rollers 11b, 11c, and 11d are positioned at the respective nip forming positions by the biasing forces.

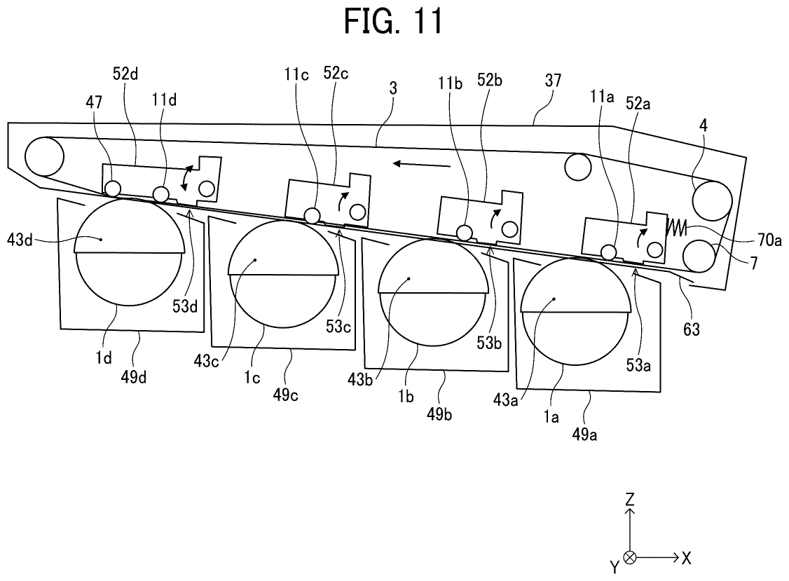

FIG. 11 is a diagram illustrating positioning of the primary transfer rollers 11a, 11b, 11c, and 11d and the surroundings thereof, on the front side of the printer 100, in which the primary transfer rollers 11a, 11b, 11c, and 11d are positioned by the positioning protrusions 53a, 53b, 53c, and 53d, respectively, of the holders 52a, 52b, 52c, and 52d, respectively, disposed on the front side of the printer 100. FIG. 12 is a diagram illustrating the primary transfer rollers 11a, 11b, 11c, and 11d and the surroundings thereof, viewed from the front side of the printer 100, in which the primary transfer rollers 11a, 11b, 11c, and 11d are positioned by the positioning protrusions 53a, 53b, 53c, and 53d, respectively, of the holders 52a, 52b, 52c, and 52d disposed on the rear side of the printer 100.

As illustrated in FIG. 11, the intermediate transfer frame 37 on the front side of the printer 100 includes a positioning member 63 extending from the intermediate transfer frame 37 in the axial direction. The positioning protrusions 53a, 53b, 53c, and 53d of the holders 52a, 52b, 52c, and 52d, respectively, on the front side of the printer 100 contact the positioning member 63 by the biasing force of the pressure springs 70a, 70b, 70c, and 70d, respectively (see FIGS. 13 and 14 for the pressure springs 70b, 70c, and 70d). Accordingly, the intermediate transfer belt 3 contacts the primary transfer rollers 11a, 11b, 11c, and 11d. Thus, the ends of the primary transfer rollers 11a, 11b, 11c, and 11d in the axial direction on the front side of the printer 100 are positioned at respective nip forming positions as desired, at which the primary transfer nips are to be formed.

As described above, the ends of the primary transfer rollers 11a, 11b, 11c, and 11d in the axial direction on the front side of the printer 100 are positioned by the intermediate transfer frame 37. Accordingly, the positioning protrusions 53a, 53b, 53c, and 53d of the holders 52a, 52b, 52c, and 52d, respectively, on the front side of the printer 100 contact the positioning member 63 to position the primary transfer rollers 11a, 11b, 11c, and 11d, respectively. By so doing, the ends of the primary transfer rollers 11a, 11b, 11c, and 11d in the axial direction on the front side of the printer 100 are positioned by the positioning protrusions 53a, 53b, 53c, and 53d, respectively. Accordingly, the assembly error and the dimensional error of the components are not accumulated, and the ends of the primary transfer rollers 11a, 11b, 11c, and 11d in the axial direction on the front side of the printer 100 can be accurately positioned with respect to the photoconductors 1a, 1b, 1c, and 1d, respectively.

As illustrated in FIG. 12, the positioning protrusions 53a, 53b, 53c, and 53d of the holders 52a, 52b, 52c, and 52d, respectively, on the rear side of the printer 100 contact the photoconductor frames 49a, 49b, 49c, and 49d, respectively. The photoconductor frames 49a, 49b, 49c, and 49d rotatably hold the photoconductors 1a, 1b, 1c, and 1d, respectively, by the biasing force of the pressure springs 70a, 70b, 70c, and 70d, respectively (see FIGS. 13 and 14 for the pressure springs 70b, 70c, and 70d). As a result, the ends of the primary transfer rollers 11a, 11b, 11c, and 11d in the axial direction on the rear side of the printer 100 are positioned at the respective nip forming positions. As described above, the ends of the primary transfer rollers 11a, 11b, 11c, and 11d in the axial direction on the rear side of the printer 100 are positioned by the photoconductor frames 49a, 49b, 49c, and 49d, respectively, that holds the photoconductors 1a, 1b, 1c, and 1d, respectively. For this reason, the ends of the primary transfer rollers 11a, 11b, 11c, and 11d in the axial direction on the rear side of the printer 100 can be accurately positioned with respect to the photoconductors 1a, 1b, 1c, and 1d, respectively.

Alternatively, the positioning protrusions 53a, 53b, 53c, and 53d of the holders 52a, 52b, 52c, and 52d, respectively, may contact the positioning holders 48a, 48b, 48c, and 48d, respectively, that position the photoconductors 1a, 1b, 1c, and 1d, respectively in the apparatus body 101. By so doing, the ends of the primary transfer rollers 11a, 11b, 11c, and 11d in the axial direction on the rear side of the printer 100 may be positioned at the respective nip forming positions.

As described above, the primary transfer rollers 11a, 11b, 11c, and 11d are accurately positioned on the front side and the rear side of the printer 100 with respect to the photoconductors 1a, 1b, 1c, and 1d, respectively, at the respective nip forming positions. Accordingly, the primary transfer nip can be formed as desired in the width direction of the intermediate transfer belt 3. Accordingly, variations of image density in the width direction of the intermediate transfer belt 3 can be reduced, and a good quality image can be obtained.

Next, a description is given of the separator 80 that moves the primary transfer rollers 11b for magenta, 11c for cyan, 11d for yellow, and the backup roller 47 to the respective retracted positions to separate the intermediate transfer belt 3 from the photoconductors 1b, 1c, and 1d.

FIGS. 13A, 13B, and 14 are schematic diagrams each illustrating the separator 80. FIGS. 13A and 13B are diagrams each illustrating the separator 80 when the separator 80 operates in the full-color mode in which the primary transfer rollers 11b, 11c, 11d, and the backup roller 47 are positioned at the respective nip forming positions. FIGS. 14A and 14B are diagrams each illustrating the separator 80 when the separator 80 operates in the monochrome mode in which the primary transfer rollers 11b, 11c, 11d, and the backup roller 47 are positioned at the respective retracted positions. FIGS. 13A and 14A are diagrams each illustrating the separator 80 as viewed from the axial direction (Y direction). FIGS. 13B and 14B are cross-sectional views of the separator 80 along a line A-A of FIGS. 13A and 14A, respectively.

The belt separators 80 are disposed on both sides in the front-rear direction of the printer 100. The two belt separators 80 that are disposed on the both sides in the front-rear direction of the printer 100 are substantially symmetrical. For this reason, a description is given of only the separator 80 on the rear side of the printer 100.

The separator 80 includes a slider 81, a cam 82, and three pressure relays 83b for magenta, 83c for cyan, and 83d for yellow.

The slider 81 is slidably held by the intermediate transfer frame 37 in the left-and-right direction of the printer 100 (the left-and-right direction in FIGS. 13A, 13B, 14A, and 14B).

The slider 81 is biased by a contact-separation spring 84 toward the cam 82 (rightward in FIGS. 13A and 14A), and a cam contact member 86 that is disposed at an end of the slider 81 contacts the cam 82. The cam 82 is fixed to a cam shaft 82a rotatably supported by the apparatus body 101 and rotationally driven by a driving force transmitted from a driving motor as a driving source disposed in the apparatus body 101 via a drive transmission member such as a gear. The slider 81 includes spring seats 85b, 85c, and 85d that are engaged with one ends (right ends in FIGS. 13A and 14A) of the pressure springs 70b, 70c, and 70d, respectively. The spring seats 85b, 85c, and 85d extend from the body of the slider 81 toward the rear side of the printer 100, and are positioned in the pressure relays 83b, 83c, and 83d, respectively, disposed outside the slider 81.

The slider 81 has through holes 90b, 90c, and 90d through which the pressed portions 55b, 55c, and 55d, respectively, penetrate. The pressed portions 55a, 55b, 55c, and 55d extend toward the rear side of the holders 52b, 52c, and 52d, respectively. The pressed portions 55b, 55c, and 55d of the holders 52b, 52c, and 52d, respectively, penetrate the through holes 90b, 90c, and 90d, respectively, of the slider 81. Distal ends of the pressed portions 55b, 55c, and 55d are positioned inside the pressure relays 83b, 83c, and 83d, respectively.

The three pressure relays 83b, 83c, and 83d are slidably held by the slider 81 or the intermediate transfer frame 37 in the left-and-right direction of the printer 100 (the left-and-right direction in FIGS. 13A, 13B, 14A and 14B). The pressure springs 70b, 70c, and 70d that bias the holders 52b, 52c, and 52d, respectively, are disposed in the pressure relays 83b, 83c, and 83d, respectively. One end (right end in FIGS. 13A, 13B, 14A and 14B) of each of the pressure springs 70b, 70c, and 70d is engaged with the spring seats 85b, 85c, and 85d, respectively, disposed in the slider 81. The other ends (left ends of the pressure springs 70b, 70c, and 70d in FIGS. 13A, 13B, 14A and 14B) of the pressure springs 70b, 70c, and 70d are engaged with side walls 89b, 89c, 89d, respectively. The pressure springs 70b, 70c, and 70d are engaged with the spring seats 85b, 85c, and 85d, respectively, of the slider 81 and the side wall 89b, 89c, 89d, respectively, at the left ends of the pressure relays 83b, 83c, and 83d, respectively, when the pressure springs 70b, 70c, and 70d are compressed.

The pressure relays 83b, 83c, and 83d include first pressing members 87b, 87c, and 87d, respectively, and second pressing members 88b, 88c, and 88d, respectively. The first pressing members 87b, 87c, and 87d are side walls of the pressure relays 83b, 83c, and 83d, respectively, located at the right ends of the pressure relays 83b, 83c, and 83d, respectively. The second pressing members 88b, 88c, and 88d are positioned between the spring seats 85b, 85c, and 85d, respectively, of the slider 81 and the pressed portions 55b, 55c, and 55d, respectively, of the holders 52b, 52c, and 52d, respectively. The second pressing members 88b, 88c, and 88d are disposed to partition the spring seats 85b, 85c, and 85d, respectively, and the pressed portions 55b, 55c, and 55d, respectively.

As illustrated in FIGS. 13A and 13B, in the full-color mode, the spring seats 85b, 85c, and 85d of the slider 81 and the second pressing members 88b, 88c, and 88d, respectively, are separated from each other. At this time, the pressure relays 83b, 83c, and 83d are biased in the left direction in FIGS. 13A and 13B by the biasing force of the pressure springs 70b, 70c, and 70d, respectively. The first pressing members 87b, 87c, and 87d bias the pressed portions 55b, 55c, and 55d, respectively, of the holders 52b, 52c, and 52d, respectively, in the left direction in FIGS. 13A and 13B. The pressed portions 55b, 55c, and 55d of the holders 52b, 52c, and 52d, respectively, are biased by the biasing force of the pressure springs 70b, 70c, and 70d, respectively, via the first pressing members 87b, 87c, and 87d, respectively. By so doing, the holders 52b, 52c, and 52d rotate in the counterclockwise direction illustrated in FIG. 10A with the support shaft 39b, 39c, and 39d, respectively, as fulcrums. As a result, as illustrated in FIG. 11, the positioning protrusions 53b, 53c, and 53d of the holders 52b, 52c, and 52d, respectively, contact the positioning member 63. Accordingly, the primary transfer rollers 11b, 11c, and 11d and the backup roller 47 are positioned at the respective target nip forming positions.

When the full-color mode is switched to the monochrome mode, the drive motor is driven to rotate the cam 82. When the cam 82 rotates from a state illustrated in FIG. 13A, the slider 81 slides to the right side in FIG. 13A, in a direction opposite to the direction in which the pressure springs 70b, 70c, and 70d bias the holders 52b, 52c, and 52d, respectively, via the pressure relays 83b, 83c, and 83d, respectively, by the biasing force of the contact-separation spring 84.

The slider 81 slides in the right direction in FIG. 13A relative to the pressure relays 83b, 83c, and 83d. When the slider 81 slides in the right direction, the spring seats 85b, 85c, and 85d move to the right side by a clearance X in FIG. 13A, and distances between the spring seats 85b, 85c, and 85d of the slider 81 and the side wall 89b, 89c, 89d, respectively, on the left side of the pressure relays 83b, 83c, and 83d, respectively, increase. As a result, the pressure springs 70b, 70c, and 70d extend while the pressure springs 70b, 70c, and 70d are compressed, and the biasing force of the pressure springs 70b, 70c, and 70d is reduced.

When the cam 82 further rotates to cause the slider 81 to slide to the right side in FIG. 13A, the spring seats 85b, 85c, and 85d contact the second pressing members 88b, 88c, and 88d, respectively. When the cam 82 still further rotates from this state, and the slider 81 further slides to the right side in FIG. 13A, the spring seats 85b, 85c, and 85d presses the second pressing members 88b, 88c, and 88d, respectively, in the right direction in FIG. 13A. Accordingly, the pressure relays 83b, 83c, and 83d slide to the right side in FIG. 13A together with the slider 81. As a result, the first pressing members 87b, 87c, and 87d are separated from the pressed portions 55b, 55c, and 55d, respectively, of the holders 52b, 52c, and 52d, respectively. By so doing, the second pressing members 88b, 88c, and 88d contact the pressed portions 55b, 55c, and 55d, respectively, as illustrated in FIGS. 14A and 14B. When the slider 81 further slides to the right side in FIG. 13A, the pressed portions 55b, 55c, and 55d are pressed to the right side by the second pressing members 88b, 88c, and 88d, respectively. When the pressed portions 55b, 55c, and 55d are pressed to the right side, the holders 52b, 52c, and 52d are rotated clockwise in FIG. 10A about the support shaft 39b, 39c, and 39d, respectively. Accordingly, the primary transfer rollers 11b, 11c, 11d, and the backup roller 47 are moved from the respective nip forming positions to the respective retracted positions illustrated in FIG. 10A.

Subsequently, when the cam 82 rotates by half as illustrated in FIG. 14A, the primary transfer rollers 11b, 11c, 11d, and the backup roller 47 are positioned at the respective retracted positions illustrated in FIG. 10B, and the rotational driving of the cam 82 is stopped.

When the cam 82 is rotated from the state illustrated in FIGS. 14A and 14B by driving the drive motor to switch from the monochrome mode to the full-color mode, the slider 81 slides to the left side in FIGS. 14A and 14B against the biasing force of the contact-separation spring 84. The pressure relays 83b, 83c, and 83d slide to the left side of FIGS. 14A and 14B together with the slider 81 until the pressed portions 55b, 55c, and 55d of the holders 52b, 52c, and 52d, respectively, contact the first pressing members 87b, 87c, and 87d, respectively. When the pressed portions 55b, 55c, and 55d contact the first pressing members 87b, 87c, and 87d, respectively, only the slider 81 slides to the left side in FIGS. 14A and 14B until the biasing force that biases the side wall 89b, 89c, 89d, at one ends of the pressure springs 70b, 70c, and 70d, respectively, of the pressure relays 83b, 83c, and 83d is equal to or larger than the force needed to rotate the holders 52b, 52c, and 52d. As a result, the spring seats 85b, 85c, and 85d are separated from the second pressing members 88b, 88c, and 88d, respectively, and the pressure springs 70b, 70c, and 70d are compressed. Subsequently, when the biasing force of the pressure springs 70b, 70c, and 70d is equal to or larger than the force needed to rotate the holders 52b, 52c, and 52d, the pressure relays 83b, 83c, and 83d move to the left side in FIGS. 14A and 14B again together with the slider 81. When the positioning protrusions 53b, 53c, and 53d of the holders 52b, 52c, and 52d, respectively, contact the positioning member 63, the primary transfer rollers 11b, 11c, 11d, and the backup roller 47 are positioned at the respective nip forming positions as desired. By so doing, the movement of the pressure relays 83b, 83c, and 83d to the left side in FIGS. 14A and 14B is stopped, and only the slider 81 moves to the left side in FIGS. 14A and 14B. Accordingly, the pressure springs 70b, 70c, and 70d are further compressed, and the biasing force of the pressure springs 70b, 70c, and 70d increases. When the cam 82 rotates by half and enters the state illustrated in FIGS. 13A and 13B, the biasing force of the pressure springs 70b, 70c, and 70d becomes a desired biasing force. Accordingly, the holders 52b, 52c, and 52d can be biased with the desired biasing force via the pressure relays 83b, 83c, and 83d, respectively.

Unlike embodiments of the present disclosure, for example, when the spring seats 85b, 85c, and 85d that are engaged with one ends of the pressure springs 70b, 70c, and 70d, respectively, are disposed on the intermediate transfer frame 37, disadvantages as follows occur. In other words, when the full-color mode is switched to the monochrome mode, the pressure relays 83b, 83c, and 83d move toward the cam 82 together with the slider 81. At this time, the distances between the spring seats 85b, 85c, and 85d, which are disposed on the intermediate transfer frame 37, and the side wall 89b, 89c, 89d, respectively, of the pressure relays 83b, 83c, and 83d, respectively, are reduced. As a result, the compressed pressure springs 70b, 70c, and 70d are further compressed. Accordingly, the biasing force of the pressure springs 70b, 70c, and 70d increases. For this reason, the slider 81 needs to be moved to the right side in FIGS. 14A and 14B against the increased biasing force of the pressure springs 70b, 70c, and 70d. Accordingly, the force that is needed to slide the slider 81 increases. In order to move the slider 81 to the right side in FIGS. 14A and 14B against the biasing force of the pressure springs 70b, 70c, and 70d, it is necessary to increase the biasing force of the contact-separation spring 84. The contact-separation spring 84, which is a tension spring, contracts as the slider 81 moves to the right side in FIGS. 14A and 14B toward the cam 82, and the biasing force of the contact-separation spring 84 decreases. For this reason, even when the biasing force of the contact-separation spring 84 decreases, the biasing force of the contact-separation spring 84 needs to be larger than the biasing force of the pressure springs 70b, 70c, and 70d. As a result, when the monochrome mode is switched to the full-color mode, the torque, which is needed to rotate the cam 82 to move the slider 81 to the left side in FIGS. 14A and 14B against the biasing force of the contact-separation spring 84, increases. In addition, the biasing force of the contact-separation spring 84 increases. Accordingly, stress that is applied to the slider 81 increases in the state illustrated in FIGS. 13A and 13B (in the full-color mode). Accordingly, the slider 81 may be broken.

By contrast, in the present embodiment, the spring seats 85b, 85c, and 85d that are engaged with one ends of the pressure springs 70b, 70c, and 70d, respectively, are disposed in the slider 81. Accordingly, the spring seats 85b, 85c, and 85d contact the second pressing members 88b, 88c, and 88d, respectively, and the pressure relays 83b, 83c, and 83d slide to the right side in FIGS. 13A and 13B together with the slider 81 against the biasing force of the pressure springs 70b, 70c, and 70d, respectively. At this time, the spring seats 85b, 85c, and 85d of the slider 81 also slide to the right side in FIGS. 13A and 13B by the same amount. Accordingly, the distances between the spring seats 85b, 85c, and 85d and the side wall 89b, 89c, 89d, respectively, are substantially constant, and the lengths of the pressure springs 70b, 70c, and 70d are substantially constant. Accordingly, the biasing forces of the pressure springs 70b, 70c, and 70d are maintained substantially constant. Such a configuration can prevent the force needed to slide the slider 81 to the right side in FIGS. 13A and 13B from increasing, compared to a case in which one ends of the pressure springs 70b, 70c, and 70d are engaged with the intermediate transfer frame 37. As a result, even if the biasing force of the contact-separation spring 84 is weak, the slider 81 can be slid to the right side in FIGS. 13A and 13B by the biasing force of the contact-separation spring 84. Accordingly, the torque that is needed to rotate the cam 82 to move the slider 81 from the position illustrated in FIGS. 14A and 14B to the left side illustrated in FIGS. 13A and 13B can be prevented from increasing against the biasing force of the contact-separation spring 84, when the monochrome mode is switched to the full-color mode.

In the present embodiment, as illustrated in FIG. 13B, in the holder 52d that holds the primary transfer roller 11d for yellow and the backup roller 47, a distance L from the support shaft 39d, which is the fulcrum of the rotation of the holder 52d, to the backup roller 47 is long. Accordingly, the force that is needed to cause the backup roller 47 to contact the intermediate transfer belt 3 at a desired contact pressure increases. For this reason, the biasing force of the pressure spring 70d also needs to be larger than the biasing forces of the other pressure springs 70b and 70c.

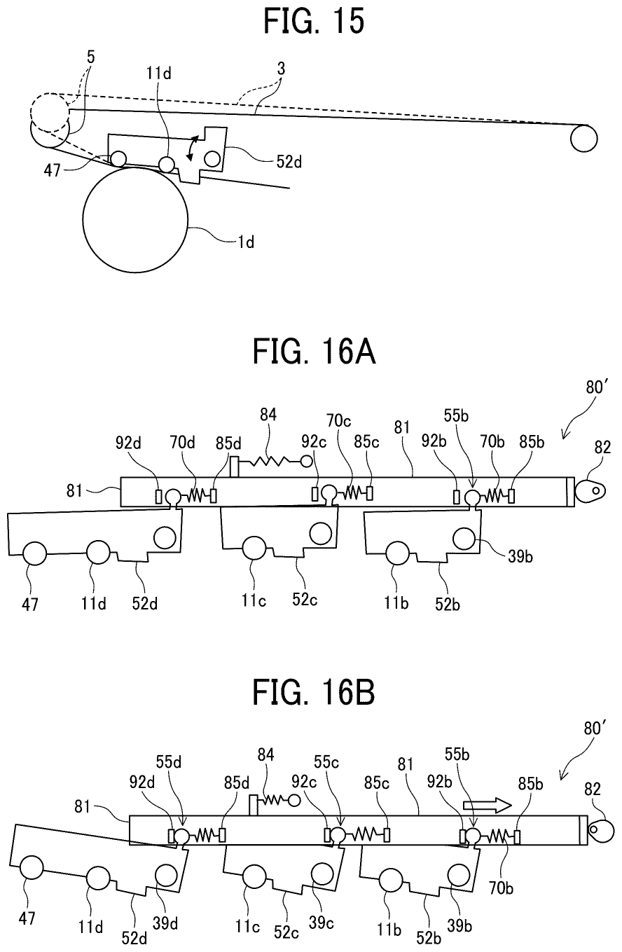

Further, in the present embodiment, the skew correction mechanism 29 inclines the tension roller 5 to correct skewing of the intermediate transfer belt 3. As illustrated in FIG. 15, the winding angle of the intermediate transfer belt 3 wound around the backup roller 47 changes depending on the inclination of the tension roller 5. As a result, the force that the holder 52d holding the backup roller 47 receives from the intermediate transfer belt 3 also changes. When the biasing force (pressing forces) of the pressure spring 70d for positioning the primary transfer roller 11d for yellow at the nip forming position is weak, the holder 52d may rotate clockwise in FIG. 15, depending on the force received by the backup roller 47. As a result, the position of the primary transfer roller 11d for yellow becomes unstable. For this reason, the biasing force of the pressure spring 70d needs to be set such that the holder 52d does not rotate regardless of the posture of the tension roller 5. Setting the biasing force of the pressure spring 70d as described above allows the position of the primary transfer roller 11d for yellow held by the holder 52d to be always the same position. Accordingly, a good quality image with little density deviation can be obtained. However, when the biasing force of the pressure spring 70d is set as described above, the biasing force of the pressure spring 70d becomes larger than the biasing force of the other pressure springs 70b and 70c.

In the present embodiment, as described above, the biasing force of the pressure springs 70b, 70c, and 70d does not increase when the full-color mode is switched to the monochrome mode. Accordingly, the force that is needed to slide the slider 81 when the color mode is switched to the monochrome mode is prevented from increasing. Accordingly, even when a spring having a strong biasing force is used as the pressure spring 70d, the slider 81 can be slid toward the cam 82 by a weak biasing force of the contact-separation spring 84. For this reason, it is possible to prevent the torque needed to rotate the cam 82 from increasing when the monochrome mode is switched to the full-color mode, i.e., when the slider 81 is slid against the biasing force of the contact-separation spring 84.

In the present embodiment, as illustrated in FIG. 13B, when the primary transfer rollers 11b, 11c, 11d, and the backup roller 47 are located at the respective nip forming positions, the spring seats 85b, 85c, and 85d are separated from the second pressing members 88b, 88c, and 88d, respectively. Accordingly, until the spring seats 85b, 85c, and 85d contact the second pressing members 88b, 88c, and 88d, respectively, and the pressure relays 83b, 83c, and 83d slide together with the slider 81, the compressed pressure springs 70b, 70c, and 70d extend. Thus, it is possible to weaken the biasing force of the pressure springs 70b, 70c, and 70d. Accordingly, the biasing force of the contact-separation spring 84 can be further weakened. Thus, the torque that is needed to rotate the cam 82 can be prevented from increasing when the monochrome mode is switched to the full-color mode, i.e., when the slider 81 is slid against the biasing force of the contact-separation spring 84.

As illustrated in FIG. 13B, when the primary transfer rollers 11b, 11c, 11d, and the backup roller 47 are located at the respective nip forming positions, the second pressing members 88b, 88c, and 88d are separated from the pressed portions 55b, 55c, and 55d, respectively. Such a configuration allows the holders 52b, 52c, and 52d to be positioned such that the primary transfer rollers 11b, 11c, and 11d are movable from the respective nip forming positions to the respective retracted positions by the gap between the second pressing members 88b, 88c, and 88d and the pressed portions 55b, 55c, and 55d, respectively.

In the present embodiment, the movement amount of the primary transfer roller 11d for yellow from the nip forming position to the retracted position is 4 mm, the movement amount of the primary transfer roller 11c for magenta is 3 mm, and the movement amount of the primary transfer roller 11b for cyan is 2 mm. Thus, the movement amounts of the primary transfer rollers 11b, 11c, and 11d are different from each other. In the present embodiment, the timing at which the second pressing members 88b, 88c, and 88d contact the pressed portions 55b, 55c, and 55d, respectively, of the holders 52b, 52c, and 52d, respectively, and the distances between the support shaft 39b, 39c, and 39d that rotatably support the holders 52b, 52c, and 52d, respectively and the primary transfer rollers 11b, 11c, and 11d, respectively, are adjusted. Thus, the movement amounts of the primary transfer rollers 11b for yellow, 11c for magenta, and 11d for cyan from the respective nip forming positions to the respective retracted positions are different from each other.

In the present embodiment, the spring seats 85b, 85c, and 85d in the state illustrated in FIG. 13A are separated from the second pressing members 88b, 88c, and 88d, respectively, by a distance X. In the present embodiment, the distance X is 1.5 mm. The distance X is 0 mm or greater even if the dimensional tolerance of the finished parts is accumulated. Longer the distance X, larger the amount of extension of the compressed pressure springs 70b, 70c, and 70d. Accordingly, the biasing force of the pressure springs 70b, 70c, and 70d is reduced when the full-color mode is switched to the monochrome mode, and the biasing force of the contact-separation spring 84 can be reduced. However, the sliding amount of the slider 81 increases, and the size of the intermediate transfer unit 60 may be increased in the left-right direction of the printer 100. In addition, the movement amount of the primary transfer rollers 11b, 11c, and 11d, i.e., the rotation amount of the holders 52b, 52c, and 52d, between the respective nip forming positions and the respective retracted positions is reduced. Accordingly, in the present embodiment, the distance X between the spring seats 85b, 85c, and 85d and the second pressing members 88b, 88c, and 88d, respectively, is 1.5 mm, which is shorter than the movement amount (movement distance) of the primary transfer rollers 11b, 11c, and 11d from the respective nip forming positions to the respective retracted positions.

FIGS. 16A and 16B are diagrams each illustrating a separator 80′ according to a modification of the above embodiments of the present disclosure.

FIG. 16A is a diagram illustrating the separator 80′ in the full-color mode. FIG. 16B is a diagram illustrating the separator 80′ in the monochrome mode.

As illustrated in FIGS. 16A and 16B, in the present modification, the pressure relays 83b, 83c, and 83d are eliminated. The one ends of the pressure springs 70b, 70c, and 70d are engaged with the pressed portions 55b, 55c, and 55d, respectively, of the holders 52b, 52c, and 52d, respectively. In the present modification also, the pressure springs 70b, 70c, and 70d are engaged with the pressed portions 55b, 55c, and 55d, respectively, and the spring seats 85b, 85c, and 85d, respectively, disposed in the slider 81 in the state in which the pressure springs 70b, 70c, and 70d are compressed.

As illustrated in FIG. 16A, in the full-color mode, pressing members 92b, 92c, and 92d disposed in the slider 81 are separated from the pressed portions 55b, 55c, and 55d, respectively, and the pressed portions 55b, 55c, and 55d are pressed in the left direction in FIG. 16A by the biasing force of the compressed pressure springs 70b, 70c, and 70d, respectively. As a result, the holders 52b, 52c, and 52d rotate counterclockwise in FIG. 16A, and the primary transfer rollers 11b, 11c, and 11d are positioned at the respective nip forming positions.

When the full-color mode is switched to the monochrome mode, the cam 82 is rotated to move the slider 81 in the right side in FIG. 16A, as described above. Only the spring seats 85b, 85c, and 85d move to the right side in FIG. 16A until the pressing members 92b, 92c, and 92d of the slider 81 contact the pressed portions 55b, 55c, and 55d, respectively, of the holders 52b, 52c, and 52d, respectively. Accordingly, the compressed pressure springs 70b, 70c, and 70d extend, and the biasing force of the pressure springs 70b, 70c, and 70d decreases. The slider 81 further moves to the right side in FIG. 16A, and the pressing members 92b, 92c, and 92d of the slider 81 contact the pressed portions 55b, 55c, and 55d, respectively, to press the pressed portions 55b, 55c, and 55d, respectively, in a direction (right side in FIG. 16A) opposite to a direction in which the pressure springs 70b, 70c, and 70d press the pressed portions 55b, 55c, and 55d, respectively. Accordingly, the pressed portions 55b, 55c, and 55d move to the right side in FIG. 16A against the biasing force of the pressure springs 70b, 70c, and 70d, respectively, and the holders 52b, 52c, and 52d rotate clockwise in FIG. 16A. Accordingly, the primary transfer rollers 11b, 11c, and 11d move from the respective nip forming positions to the respective retracted positions illustrated in FIG. 16B.

Also in this modification, when the full-color mode is switched to the monochrome mode, the spring seats 85b, 85c, and 85d move to the right side in FIG. 16B by substantially the same amount as the amount in which the pressed portions 55b, 55c, and 55d are pressed by the pressing members 92b, 92c, and 92d, respectively. Accordingly, the length of the pressure springs 70b, 70c, and 70d is maintained substantially constant. Such a configuration prevents the biasing force of the pressure springs 70b, 70c, and 70d from increasing when the primary transfer rollers 11b, 11c, and 11d are moved from the respective nip forming positions to the respective retracted positions. Thus, the biasing force of the contact-separation spring 84 can be reduced. Accordingly, the rotational torque of the cam 82 can be prevented from increasing when the monochrome mode in which the slider 81 is slid against the biasing force of the contact-separation spring 84 is switched to the full-color mode.

The separator 80′ of the present modification does not include the pressure relays 83b, 83c, and 83d. Thus, the number of components can be reduced. Accordingly, the size of the printer 100 in the front-rear direction can be reduced, and cost reduction of the printer 100 can be achieved compared with the above-described embodiments.

By contrast, the separator 80 of the above-described embodiments includes the pressure relays 83b, 83c, and 83d and has the following advantages compared to the separator 80′ of the modification illustrated in FIGS. 16A and 16B. In other words, in the above-described embodiments, the holders 52a, 52b, 52c, and 52d rotate. By so doing, the primary transfer rollers 11b, 11c, and 11d are moved from the respective nip forming positions to the respective retracted positions. Accordingly, when the holders 52a, 52b, 52c, and 52d rotate, the pressed portions 55b, 55c, and 55d are also moved in the vertical direction (Z direction) of the printer 100. In the configuration in which the one ends of the pressure springs 70b, 70c, and 70d are directly engaged with the pressed portions 55b, 55c, and 55d, respectively, as in the modification, the pressure springs 70b, 70c, and 70d are bent when the pressed portions 55b, 55c, and 55d are moved in the vertical direction. Accordingly, an unnecessary force is applied to the pressed portions 55b, 55c, and 55d. As a result, the rotational torque of the cam 82 may increase, or the pressure springs 70b, 70c, and 70d may be detached from the pressed portions 55b, 55c, and 55d, respectively.

By contrast, the separator 80 of the above-described embodiments includes the pressure relays 83b, 83c, and 83d. By so doing, the pressure relays 83b, 83c, and 83d can always press the pressed portions 55b, 55c, and 55d, respectively, in the horizontal direction, i.e., the right-left direction of the printer 100 (the X direction in FIGS. 13A, 13B, 14A, and 14B). Accordingly, an unnecessary force in the vertical direction is not applied to the pressed portions 55b, 55c, and 55d, and the holders 52b, 52c, and 52d can be smoothly rotated. Thus, the rotational torque of the cam 82 can be prevented from increasing appropriately.

In the above-described embodiments, the cam 82 is disposed downstream (right side in FIGS. 13A, 13B, 14A and 14B) from the slider 81 in the direction in which the slider 81 is slid when the full-color mode is switched to the monochrome mode. However, the cam 82 may be disposed upstream (left side in FIGS. 13A, 13B, 14A, and 14B) in the direction in which the slider 81 is slid when the full-color mode is switched to the monochrome mode. In such a configuration, the biasing force of the pressure springs 70b, 70c, and 70d increases when the full-color mode is switched to the monochrome mode. Accordingly, the torque that is needed to rotate the cam 82 increases when the full-color mode is switched to the monochrome mode. However, the spring seats 85b, 85c, and 85d are disposed in the slider 81 to prevent the biasing force of the pressure springs 70b, 70c, and 70d from increasing when the full-color mode is switched to the monochrome mode. By so doing, the torque that is necessary to rotate the cam 82 can be prevented from increasing.

The above-described embodiments are illustrative and do not limit the embodiments of the present disclosure. Thus, numerous additional modifications and variations are possible in light of the above teachings. For example, elements and/or features of different illustrative embodiments may be combined with each other and/or substituted for each other within the scope of the present disclosure.

The embodiments described above are just examples, and the various aspects of the present disclosure attain respective effects as follows.

### First Aspect

An image forming apparatus includes an image bearer such as the photoconductors 1a, 1b, 1c, and 1d, a transferor such as the intermediate transfer belt 3 onto which an image is transferred, a nip former such as the primary transfer rollers 11a, 11b, 11c, and 11d to cause the transferor to contact the image bearer to form a transfer nip; a pressure spring such as the pressure springs 70a, 70b, 70c, and 70d to press a holder such as the holders 52a, 52b, 52c, and 52d, respectively, to cause the nip former to be positioned at a nip forming position at which the transferor contacts the image bearer, and a separator such as the separator 80 including a slider such as the slider 81. The separator causes the slider to slide in a first direction opposite a second direction in which the pressure spring biases the holder to move the nip former from the nip forming position to a retracted position retracted from the nip forming position; and separate the transferor from the image bearer. An end of the pressure spring opposite another end of the pressure spring to bias the holder is engaged with the slider.

Typically, when a slider is positioned at a standby position, i.e., a nip forming position at which a nip former is positioned by the biasing force of a pressure spring, the slider is held at the standby position by a member for sliding the slider such that the slider does not slide by itself in a direction opposite a direction in which the pressure spring presses the holder to move the nip former to the retracted position. For example, in a configuration in which the member for sliding the slider includes a cam and the slider is slid by the rotation of the cam, the slider is biased by a spring to contact the cam, the slider is held at the standby position by the biasing force of the spring even when a force for sliding the slider is applied. If the member for sliding the slider includes a rack-and-pinion mechanism, the reduction ratio of a gear for transmitting the driving force of the driving source to the rack-and-pinion mechanism is increased, and the slider is held at the standby position by the torque of the driving source.

An end of the pressure spring opposite another end of the pressure spring to bias the holder is engaged with the slider. By so doing, a biasing force of the pressure spring is applied to the slider in the direction opposite a direction in which the pressure spring presses the holder to move the nip former to the retracted position. However, as described above, in the configuration in which the slider is held at the standby position by the member for sliding the slider, the slider is held at the standby position without sliding by the biasing force of the pressure spring. Accordingly, when the slider is positioned at the standby position, the pressure spring biases the holder with a desired biasing force.

When the slider is slid in a direction opposite a pressing direction in which the pressure spring presses the holder to move the nip former from the nip forming position to the retracted position, the opposite end of the pressure spring engaged with the slider moves in the opposite direction together with the slider. When the slider is slid to move the nip former from the nip forming position to the retracted position, the holder pushes the end of the pressure spring at which the pressure spring biases the holder in the opposite direction, and the end of the pressure spring at which the pressure spring biases the holder also moves in the opposite direction. Thus, both ends of the pressure spring move in the opposite direction. Accordingly, the entire pressure spring moves in the opposite direction, and the change of the length of the pressure spring is reduced. Therefore, compared to the image forming apparatus in the art in which the opposite end of the pressure spring is engaged with the frame, which does not slide, of the apparatus body, the biasing force of the pressure spring against the holder when the slider is slid can be prevented from increasing. Accordingly, the force needed to slide the slider when the transferor is separated from the image bearer can be reduced compared to the configuration of the image forming apparatus in the art.

### Second Aspect

In the image forming apparatus according to the first aspect, the holder is rotatably supported, and the separator includes a pressing relay such as the pressure relays 83b, 83c, and 83d having a first pressing member such as the first pressing members 87b, 87c, and 87d for pressing the holder by the biasing force of the pressure spring and a second pressing member such as the second pressing members 88b, 88c, and 88d moving together with the slider to press the holder in the opposite direction.

According to this configuration, unlike the configuration in which the pressure spring 70 directly presses the holder 52 as described in the above embodiments, the pressure spring is not bent by the rotation of the holder. Thus, an unnecessary force can be prevented from being generated and the load to slide the slider can be prevented from increasing.

### Third Aspect

In the image forming apparatus according to the second aspect, the sliding amount (in the present embodiment, the clearance X between the spring seats 85b, 85c, and 85d and the second pressing members 88b, 88c, and 88d, respectively) of the slider from a timing at which the slider contacts the pressure relay until the pressure relay starts to move together with the slider is smaller than a movement amount of the nip former such as the primary transfer rollers 11b, 11c, and 11d in which the nip former moves from the nip forming position to the retracted position.

According to this configuration, as described in the above embodiments, after the slider slides by a predetermined amount, the slider contacts the pressure relay, and the pressure relay moves together with the slider. Thus, the biasing force of the pressure spring can be reduced, and the force needed to cause the slider to slide can be reduced.

Further, the sliding amount of the slider (in the above embodiments, the clearance X between the spring seats 85b, 85c, and 85d and the second pressing members 88b, 88c, and 88d, respectively) is set to be smaller than the movement amount of the nip former such as the primary transfer rollers 11a, 11b, 11c, and 11d from the nip forming position to the retracted position.

### Fourth Aspect

In the image forming apparatus according to any one of the first to third aspect, the holder contact the image bearer holder such as the photoconductor frame 49 for holding the image bearer such as the photoconductors 1a, 1b, 1c, and 1d or a photoconductor positioner such as the intermediate transfer frame 37 or the positioning holders 48a, 48b, 48c, and 48d for positioning the image bearer in the apparatus body, and the nip former such as the primary transfer rollers 11a, 11b, 11c, and 11d is positioned at the nip forming position.

According to this configuration, as described in the above embodiments, the transfer nip can be accurately positioned with respect to the image bearer such as the photoconductors 1a, 1b, 1c, and 1d at the nip forming position, and the transfer nip having a favorable shape can be formed. Thus, the image on the image bearer can be transferred to the transferor such as the intermediate transfer belt 3 in a desired condition. Accordingly, a good quality image can be obtained.

### Fifth Aspect

In the image forming apparatus according to any one of the first to fourth aspect, the image forming apparatus includes multiple image bearers such as photoconductors 1a, 1b, 1c, and 1d and multiple nip formers such as the primary transfer rollers 11a, 11b, 11c, and 11d. The belt separator such as the separator 80 slides the slider to move the multiple nip formers.

According to this configuration, the nip former such as the primary transfer rollers 11a, 11b, 11c, and 11d can be moved from the nip forming position to the retracted position by the single slider.

### Sixth Aspect

In the image forming apparatus according to the fifth aspect, the image forming apparatus further includes a backup roller such as the backup roller 47, which is arranged upstream from an uppermost nip former of the multiple nip formers in the movement direction of the transferor such as the intermediate transfer belt 3 to form a transfer nip extreme upstream in the movement direction of the transferor, having a favorable shape. The backup roller is held by the holder, i.e., the holder 52d which holds the nip former arranged uppermost in the movement direction of the transferor.

According to this configuration, as described in the above embodiments, the number of components of the image forming apparatus can be reduced, and the cost of the image forming apparatus can be reduced compared to a configuration in which a holder for holding the backup roller is separately provided for the image forming apparatus.

### Seventh Aspect

In the image forming apparatus according to any one of the first or sixth aspect, the transferor is an intermediate transferor such as the intermediate transfer belt 3, and the nip former is a primary transferor, such as the primary transfer rollers 11a, 11b, 11c, and 11d, that primarily transfers an image from an image bearer such as the photoconductors 1a, 1b, 1c, and 1d to the intermediate transferor.

### Eighth Aspect

In the image forming apparatus according to any one of the first or seventh aspect, the transferor such as the intermediate transfer belt 3 is a belt, and includes a skew correction mechanism such as the skew correction mechanism 29 that inclines a rotator such as the tension roller 5 that supports the transferor to correct the belt skew.

According to this configuration, as described in the above embodiments, the transferor can stably travel in the belt width direction.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus comprising:
an image bearer;
a transferor to transfer a toner image on the image bearer;
a nip former to cause the transferor to contact the image bearer at a nip forming position to form a transfer nip between the image bearer and the transferor;
a holder to hold the nip former;
a slider slidable in a first direction;
a pressure spring having:
one end engaged with the slider; and
another end to press the holder in the first direction to position the nip former at the nip forming position; and
a separator to slide the slider in a second direction opposite the first direction to move the nip former from the nip forming position to a retracted position to separate the transferor from the image bearer.

2. The image forming apparatus according to claim 1,
wherein the holder is rotatable about a shaft, and
wherein the separator further includes a pressure relay including:
a first pressing member to press the holder with a biasing force of the pressure spring in the first direction; and
a second pressing member disposed between the pressure spring and the holder to press the holder in the second direction.

3. The image forming apparatus according to claim 2,
wherein the slider has a clearance between said another end of the pressure spring and the second pressing member when the nip former is at the nip forming position, and
the nip former moves from the nip forming position to the retracted position by a movement amount larger than a sliding amount.

4. The image forming apparatus according to claim 1, further comprising:
an image bearer holder holding the image bearer; or
a photoconductor positioner to position the image bearer in an apparatus body,
wherein the holder is contactable with the image bearer holder or the photoconductor positioner to position the nip former at the nip forming position.

5. The image forming apparatus according to claim 1, further comprising:
multiple image bearers including the image bearer; and
multiple nip formers including the nip formers,
wherein the separator slides the slider to move the multiple nip formers.

6. The image forming apparatus according to claim 5, further comprising:
a backup roller upstream from an uppermost nip former of the multiple nip formers in a movement direction of the transferor,
wherein the holder uppermost in the movement direction holds the backup roller.

7. The image forming apparatus according to claim 1,
wherein the transferor includes an intermediate transferor, and
the nip former includes a primary transferor to primarily transfer an image from the image bearer to the intermediate transferor.

8. The image forming apparatus according to claim 1, further comprising:
a rotator supporting the transferor; and
a skew correction mechanism to incline the rotator to correct skewing of the transferor,
wherein the transferor includes a belt, and
the skew correction mechanism corrects the skewing of the belt.

9. The image forming apparatus according to claim 1,
wherein the separator includes a cam rotatable to slide the slider in either the first direction or the second direction.

10. The image forming apparatus according to claim 2,
wherein the holder has a pressed portion disposed between the first pressing member and the second pressing member of the pressure relay in the first direction, and
the pressure spring is disposed in the pressure relay between the second pressing member and a side wall of the pressure relay in the first direction.
